(19) United States
(12) Patent Application Publication
(10) Pub. No.: US 2024/0138279 A1
(43) Pub. Date: May 2, 2024

(54) FIELD GUIDANCE PLAN TEMPLATE

(71) Applicant: DEERE & COMPANY, Moline, IL (US)

(72) Inventors: Glen L. Oetken, Ankeny, IA (US); David August Johnson, Durham, NC (US)

(21) Appl. No.: 17/977,827

(22) Filed: Oct. 31, 2022

(51) Int. Cl. A01B 69/04; G01C 21/20

(52) U.S. Cl. CPC A01B 69/008; G01C 21/20

(57) ABSTRACT

Systems and non-transitory computer-readable media for creating a field guidance plan template. Receiving, via an interface of an off-road work vehicle, a set of attributes associated with a defined area of a work field for a field operation of the off-road work vehicle. The set of attributes define features of the work field. Generating a field guidance plan for the defined area of the work field. The field guidance plan designed to assist the off-road work vehicle in traversing the defined area during the field operation. The field guidance plan also including a set of field guidance lines. Extracting the set of attributes of each field guidance line of the set of field guidance lines in the field guidance plan. Creating and storing a field guidance plan template based at least in part on the set of attributes the field operation.

### BACKGROUND

The present disclosure relates to a system and non-transitory computer readable medium for creating a field guidance plan template. More specifically, the present disclosure relates to a system and non-transitory computer readable medium for creating and modifying a field guidance plan template.

### SUMMARY

In one embodiment, the disclosure provides a field guidance plan system. The system including an electronic controller. The electronic controller configured to receive, via an interface of an off-road work vehicle, a set of attributes associated with a defined area of a work field for a field operation of the off-road work vehicle. The set of attributes define features of the work field. The electronic controller configured to generate a field guidance plan for the defined area of the work field. The field guidance plan designed to assist the off-road work vehicle in traversing the defined area during the field operation. The field guidance plan includes a set of field guidance lines. The electronic controller configured to extract the set of attributes of each field guidance line of the set of field guidance lines in the field guidance plan. The electronic controller configured to create and store a field guidance plan template based at least in part on the set of attributes and the field operation.

In another embodiment, the disclosure provides a field guidance plan system. The system including an electronic controller. The electronic controller configured to receive a set of attributes associated with a defined area of a tract of land for an operation of an off-road work vehicle. The electronic controller configured to generate a field guidance plan for the defined area of the field. The field guidance plan designed to assist the off-road work vehicle in traversing the defined area during a field operation. The electronic controller configured to create a field guidance plan template based on the set of attributes and the field operation.

In yet another embodiment, the disclosure provides a non-transitory computer-readable medium. The non-transitory computer-readable medium including instructions. When an electronic processor executes the instructions, the electronic processor performs a set of operations. The set of operations includes receiving a set of attributes associated with a defined area of a work field for a field operation of an off-road work vehicle. The set of attributes received with an interface of the off-road work vehicle. The set of attributes define features of the work field. The set of operations includes generating a field guidance plan for the defined area of the work field. The field guidance plan designed to assist the off-road work vehicle in traversing the defined area during the field operation. The field guidance plan is discarded after the field operation is complete. The field guidance plan includes a set of field guidance lines. The set of operations also includes extracting the set of attributes of each field guidance line of the set of field guidance lines in the field guidance plan. The set of operations also includes creating and storing a field guidance plan template based at least in part on the set of attributes and the field operation.

Other aspects of the disclosure will become apparent by consideration of the detailed description and accompanying drawings.

### BRIEF DESCRIPTION OF THE DRAWINGS

FIG. 1 is a plan view of a work field according to one embodiment.

FIG. 2 illustrates a control system schematic according to embodiments in the present disclosure.

FIG. 3 is an example of a graphical user interface that includes a field guidance plan according to embodiments in the present disclosure.

FIGS. 4A-C are illustrations of a graphical user interface for selecting and modifying a field guidance plan template according to embodiments in the present disclosure.

FIG. 5 is a flowchart of a method of creating a field guidance plan template according to embodiments in the present disclosure.

FIG. 6 is a flowchart of a method of modifying a field guidance plan template according to embodiments in the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways.

Various embodiments of the present disclosure disclose a system that creates and stores a field guidance plan template based on a field guidance plan that is designed for a single field operation for a trip through a work field, for example an agricultural or crop field. In some implementations, the system allows a user to modify the field guidance plan template for use with a similar or different field operation. In other implementations, the system notifies a user that the off-road work vehicle associated with the work field, for example an agricultural vehicle such as a tractor or combine, or other vehicle or equipment, e.g., construction equipment, mowing equipment, or the like, is not traversing the work field according to a field guidance line of the field guidance plan template. Other creation, storage, modification, and notification variations are of course contemplated herein.

A field guidance plan designed for only a single field operation limits the utility of the field guidance plan upon completion of that field operation. Currently, a field guidance plan designed for a single field operation is discarded after performance of the operation resulting in the recurrence of field guidance plan request events for a work field and related field operation. Additionally, a field guidance plan built for a single field operation may not be applicable for a different field operation. Thus, it would be advantageous to provide a field guidance plan capable of being modified to eliminate the recurrence and inefficiency of design request events necessary to generate a brand new field guidance plan each time.

Various embodiments of the present disclosure provide a system and method to retain data (e.g., attributes and metadata) associated with a field guidance plan designed for one field operation and create a field guidance plan template that is reusable for another field operation. Additionally, embodiments of the present disclosure provide a system and method to modify a field guidance plan previously built for a specific field operation and work field. Further, embodiments of the present disclosure provide a system and method to trigger alerts and other notifications for the user or operator indicating in real time that corrections are required to adhere to the field guidance plan being executed.

Enabling the ability to both save and shift field guidance lines of a designed field guidance plan advantageously permits a field guidance plan template to be reused with or without modification for other uses. For example, the system herein provides the ability to shift field guidance lines to accurately plant between a previous year's crop rows. This enables better seeding performance and yield as the seeds are placed in a specific area between rows. As another example, the system enables pass repeatability during controlled traffic farming by allowing machines to use the same field guidance lines for each field operation to keep machine wheel tracks in a specific area of a field, while also reducing, minimizing, or eliminating overlapping passes attributed to incorrect row selection for the next pass following a turn. In yet another example the system enables the efficient handling of a farming process with multiple operations. The modifiable field guide plan template allows for easy modifications that enable differing types of operations for the same field. Other features and advantages are set forth herein.

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

A plurality of hardware and software-based devices, as well as a plurality of different structural components may be used to implement various embodiments. In addition, embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (for example, stored on non-transitory computer-readable medium) executable by one or more processors. For example, “control units” and “controllers” described in the specification can include one or more electronic processors, one or more memory modules including non-transitory computer-readable medium, one or more input/output interfaces, one or more application specific integrated circuits (ASICs), and various connections (for example, a system bus) connecting the various components.

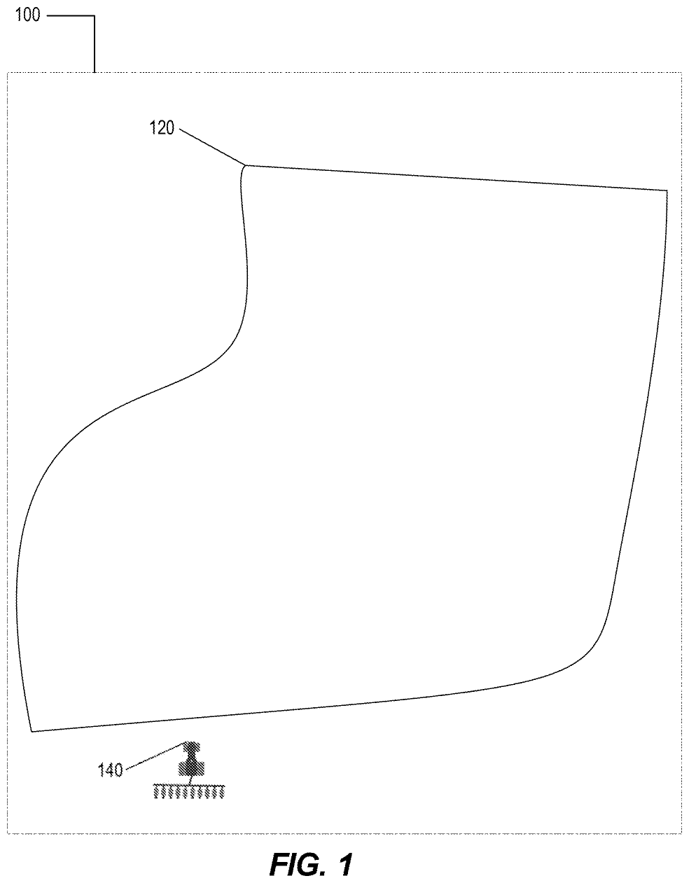

FIG. 1 illustrates an example of a plan view of a land tract 100 that includes a work field 120 and an off-road work vehicle 140, for example a tractor. The off-road work vehicle 140 performs a trip field operation while traversing the work field 120. A trip field operation is an operation performed by the off-road work vehicle 140 in the work field 120, such as planting seed, spraying weeds, harvesting, baling hay, or the like.

In some embodiments, the off-road work vehicle 140 traverses the work field 120 according to a field guidance plan. The field guidance plan is created on a display when the off-road work vehicle 140 is on the land tract 100 and/or in the work field 120. In some implementations, this field guidance plan includes field guidance lines that indicate one or more rows in the work field 120. Specifically, the field guidance plan may be created using rows of the work field 120, and the type of field operation and the width of the off-road work vehicle 140 may be used to create field guidance lines that correspond to the rows of the work field 120 when the off-road work vehicle 140 makes a pass across the work field 120. In other implementations, the field guidance plan is created using a boundary of the work field 120, headland definition of the work field 120, width of the off-road work vehicle 120, and/or heading of the off-road work vehicle 140. The headland definition of the work field 120 is an area around the work field 120 between the boundary and an area in which a crop is planted in the work field 120 and may be, for example, the width of the off-road work vehicle 140 used by the off-road work vehicle 140 for turning around with farm implements during field operations. In yet other implementations, any combination of the aforementioned may be used to create the field guidance plan and/or field guidance lines.

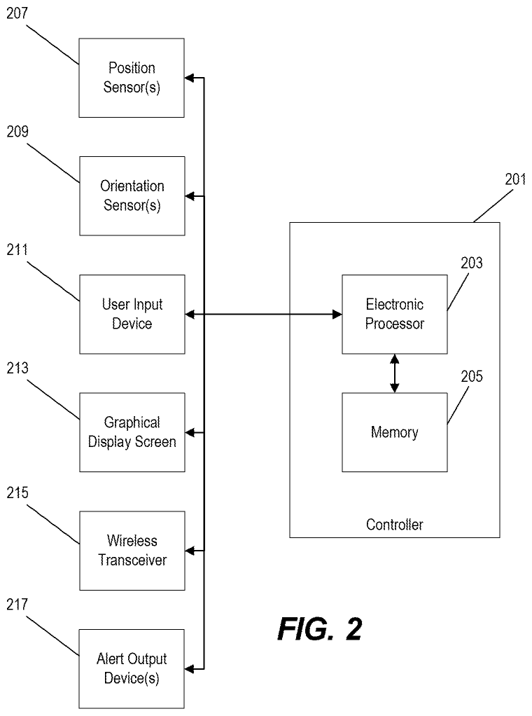

FIG. 2 illustrates an example of a control system configured to 1) create and store a field guidance plan template, 2) modify the field guidance plan template, and 3) notify a user that the off-road work vehicle 140 is not traversing the work field 120 according to a field guidance line of the field guidance plan template. The system includes a controller 201 that includes an electronic processor 203 and a non-transitory, computer-readable memory 205. The memory 205 is communicatively coupled to the processor 203 and is configured to store data and instructions that, when executed by the processor 203, cause the controller 201 to perform functionality such as described herein. The controller 201 can be physically mounted to the off-road work vehicle 140 or, in some implementations, provided as a remotely located computer system or server configured to wirelessly communicate with a local controller of the off-road work vehicle 140 and/or other individual components of off-road work vehicle 140. In some implementations, the functionality of the controller 201 as described herein may be distributed between multiple different controllers including, for example, a local controller and a remote computer system (e.g., a remote server computer) in wireless communication with each other. For example, the remote server computer represents a server computing system utilizing multiple computers as a server system, such as in a cloud computing environment. In this example, the remote server computer can be a laptop computer, a tablet computer, a netbook computer, a personal computer (PC), a desktop computer, a personal digital assistant (PDA), a smart phone, or any programmable electronic device capable of communicating with off-road work vehicle 140, other individual components of off-road work vehicle 140, and/or other computing devices (not shown) within a distributed data processing environment. In some instances, the remote server computer represents a computing system utilizing clustered computers and components (e.g., database server computers, application server computers, etc.) that act as a single pool of seamless resources when accessed within a distributed data processing environment.

In the example of FIG. 2, the off-road work vehicle 140 includes a position sensor 207, an orientation sensor 209, a user input device 211, a graphical display screen 213, a wireless transceiver 215, and an alert output device 217. While the various sensors are discussed in detail herein, it is understood that other forms of sensors mounted in different locations may also be used to collect similar information and data types. Furthermore, while the below sensors are physical in nature, it is understood that in other embodiments virtual sensors or models may also be used to detect or model the data or information needed.

The position sensor 207 is configured to provide to the controller 201 a signal associated with a geospatial location of the off-road work vehicle 140. In some embodiments, the position sensor 207 is a global navigation satellite system (GNSS) receiver with an antenna that converts signals from visible satellites into a geolocation. In some implementations, the controller 201 records the geolocation of the off-road work vehicle 140 provided by the position sensor 207 at regular time intervals to create a log of movements (e.g., set of geolocations).

The orientation sensor 209 is configured to provide to the controller 201 a signal associated with an orientation of the off-road work vehicle 140. The controller 201 can utilize the signal to determine a heading angle of the off-road work vehicle 140. In some implementations, the controller 201 records the orientation of the off-road work vehicle 140 provided by the orientation sensor 209 at regular time intervals to create a log of orientations for a pass through the work field 120. In some embodiments, the orientation sensor 209 is a gyroscope. In other embodiments, the orientation sensor 209 is any device capable of measuring a change in angular velocity.

The input device 211 is configured to receive data and control signals a user provides to the controller 201 and/or to the off-road work vehicle 140. In some embodiments, the user input device 211 is configured to communicate wirelessly with a remote device or server. In some embodiments, the off-road work vehicle 140 may include a wireless transceiver 215 (e.g., a wi-fi, RF, or other wireless transceiver). The wireless transceiver 215 is configured to transmit and receive wireless communications between the controller 201, components of the off-road work vehicle 140 capable of wireless communication, and external devices. The alert output device 217 is configured to generate a visual, auditory, and/or haptic alert output in response to receiving an alert signal.

The graphical display screen 213 (e.g., a liquid crystal display [LCD]) is configured to output data in text and/or graphical format. In some embodiments, the graphical display screen 213 includes the input device 211 (e.g., graphical user interface), which is displayed to a user to provide a touch-sensitive display unit. In some implementations, the graphical display screen 213 is included as a component of a mobile device and is configured to communicate with the controller 201 and the user input device 211 through a wired or wireless communication interface. In some implementations, the graphical display screen 213 and the user input device 211 are positioned in an operator cab of the off-road work vehicle 140.

In an embodiment, the controller 201 is configured to create a field guidance plan template for the work field 120. The controller 201 receives a set of attributes associated with a design of a field guidance plan for the work field 120. The set of attributes define features of the work field 120, such as, for example, field boundaries, angles of rows, planting area, and the like. For example, the controller 201 may receive the following (non-exclusive) attributes: a field boundary, machine track spacing, number of headland passes or headland area, vehicle width, and heading angle. In some implementations, the set of attributes includes attributes associated with the work field 120 itself and/or the off-road work vehicle 140. In some embodiments, the controller 201 is configured to receive the set of attributes from the user input device 211, one or more sensor devices of the off-road work vehicle 140, or a combination thereof. For example, the controller 201 receives the field boundary attribute from the position sensor 207 as the off-road work vehicle 140 traverses a boundary of the work field 120.

The controller 201 creates and displays a preview image of the field guidance plan on the graphical display screen 213 for the crop area 120 based on the received attributes.

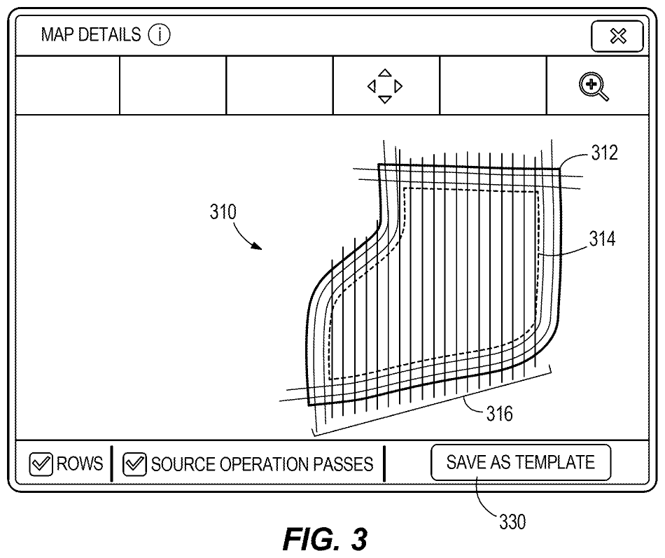

FIG. 3 is an example of a graphical user interface that includes a field guidance plan 310 for the work field 120. In FIG. 3 the graphical user interface displays the field guidance plan 310 generated by the controller 201. The field guidance plan 310 includes a field boundary line 312, headland boundary 314, and a plurality of field lines or guidelines 316. The field guidelines 316 are positioned to correspond to rows in the work field 120. The graphical user interface also includes template creation button 330, which is a graphical user interface element configured to retain data (e.g., the set of attributes) and descriptive metadata (e.g., field location, field operation, date, etc.) associated with the field guidance plan 310. In some embodiments, information required to recreate the plurality of field lines or guidelines 316 is retained.

In some implementations, the controller 201 retains the data and descriptive metadata automatically when the off-road work vehicle 140 completes the field operation, the field changes, or a field track type changes (e.g., change in heading angle of field guidance lines). In some embodiments, the controller 201 is configured to extract position data of each field guideline of the plurality of field lines or guidelines 316 from the field guidance plan 310, create a template of the field guidance plan 310 using the set of attributes, extracted position data, or both and store the field guidance plan template in the memory 205. The controller 201 may also be configured to automatically populate the file name and/or description of the field guidance plan template using the set of attributes and the metadata. For example, the controller 201 may name the field guidance plan template “spring 2022 wheat seeding—60′ @ 10″ spacing.” In some instances, the controller 201 is configured to store the field guidance plan on a non-transitory medium (e.g., USB drive) and/or transmit the field guidance plan to a remote server via the wireless transceiver 215.

In an embodiment, the controller 201 is configured to modify a field guidance plan template for the work field 120. In particular, the controller 201 is configured to retrieve the field guidance plan template from the memory 205 and to modify the field guidance plan template. In some implementations, the controller 201 retrieves one or more field guidance plan templates based on a location of off-road work vehicle 140 and a location based on one or more field guidance plan templates being within a threshold distance.

In some embodiments, the controller 201 is configured to shift a location of field guidance lines of the field guidance plan template by a defined value. The shift may be towards or away from a center of the work field 120. In some implementations, the controller 201 is configured to shift a location of a group of field guidance lines or a subset of that group, or a portion of at least one field guidance line. For instance, the controller 201 can be configured to group a set of field guidance lines based on an area (e.g., headland, crop planting area, pass number) of the field guidance plan template in which the field guidance lines are located and shift the group. In other embodiments, the controller 201 is configured to shift a location of boundary lines or a subset of boundary lines, or one boundary line, of the field guidance plan template by a defined value. As an example, the controller 201 is configured to expand or shrink a boundary line of the work field 120 in the field guidance plan template and in particular is configured to shift, by a distance and in a direction normal to a tangent of the boundary line, a location of the boundary line of the work field 120 and/or a headland area in the field guidance plan template.

In some implementations, the controller 201 is configured to shift a location of a portion of a field boundary line of the work field 120. For instance, the controller 201 can be configured to shift a location of a portion of the boundary line of the crop area 120 and/or headland area. In yet other embodiments, the controller 201 is configured to shift all or portions of both field guidance lines and boundary lines of the field guidance plan template. In some instances, the controller 201 expands a boundary line in a field guidance plan template such that field guidance lines no longer intersect with the boundary line. In those instances, the controller 201 is configured to also extend or retract the field guidance lines to intersect with the boundary line, which allows the field guidance plan template to assist the off-road work vehicle 140 in traversing the crop area 120 in an area where field guidance lines did not exist originally.

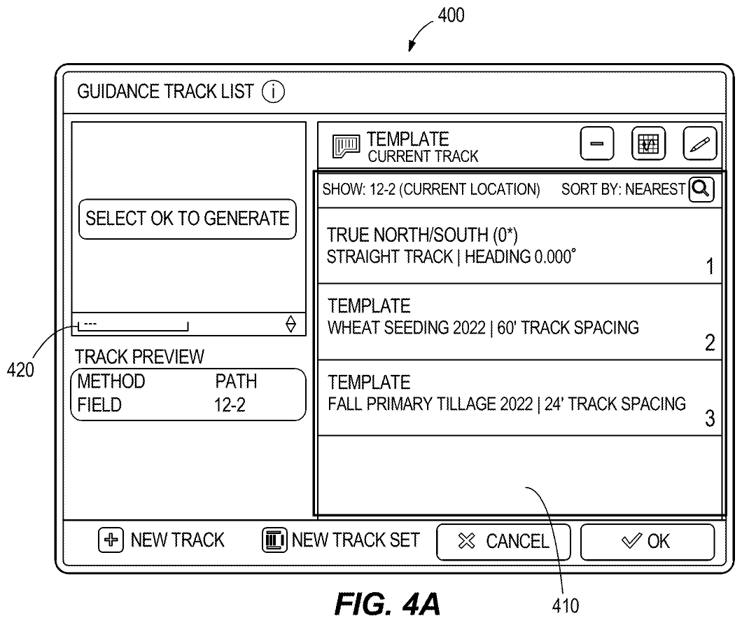

In an embodiment, the controller 201 is configured to trigger a notification that the off-road work vehicle 140 is not traversing the work field 120 according to a field guidance line of the field guidance plan template. The controller 201 receives geolocation data of the off-road work vehicle 140 from the position sensor 207 during a pass across the work field 120. The controller 201 compares a geolocation of the off-road work vehicle 140 and a location of a field guidance line of the field guidance plan template to determine whether the off-road work vehicle 140 and the field guidance line is within a threshold distance. In some instances, when the off-road work vehicle 140 is not within a threshold distance of the field guidance line, the controller 201 is configured to generate an alert signal. In some implementations, the alert signal is transmitted to the graphical display screen 213 and causes a visual alert indication to be displayed on the graphical display screen 213. In other implementations, the alert signal is transmitted to one or more alert output devices 217. The controller 201 is also configured to generate a graphical user interface (See FIGS. 3-4C) and to cause the graphical user interface to be displayed on the graphical display screen 213. In other implementations, the electronic controller 201 is configured to display the graphical user interface on a device that is remote to the off-road work vehicle 140 such as, for example, a portable computing device such as a tablet computer or a smart phone.

FIG. 4A is an example illustration of a graphical user interface 400 for selecting a field guidance plan template as discussed herein. The graphical user interface 400 includes a graphical control element 410 and a preview window 420. The graphical control element 410 includes a selection list of three (3) field guidance plan templates of the memory 205, though more or fewer than three templates may be selectable or displayed. The selection list is retrieved based on a current location of the off-road work vehicle 140. The graphical control element 410 is configured to receive a user selection of a field guidance plan template. The preview window 420 is configured to display an image of the field guidance plan template selected.

In FIG. 4B, the controller 201 has received a selection of the user that corresponds to field guidance plan template No. 3 of the selection list of the graphical control element 410. In this example, the controller 201 generates a preview image of the selected guidance plan template (e.g., the field guidance plan template three) using a set of attributes associated with the field guidance plan template No. 3, which is displayed by the preview window 420.

FIG. 4C is an example illustration of a graphical user interface 440 for modifying the field guidance plan template of FIG. 4B. The graphical user interface 440 includes the template creation button 330, the preview window 420, a boundary control element 442, and a field line control element 444. The boundary control element 442 is configured to receive distance and direction values from a user. The controller 201 is configured to modify a boundary line of the selected field guidance plan template based on the distance and direction values received. The field line control element 444 is also configured to receive distance and direction values from a user. The controller 201 is configured to modify a field guidance line of the selected field guidance plan template based on the distance and direction values received while maintaining the heading angle of the field guidance line. In some instances, modifying the boundary line also modifies the field guidance line positions to maintain groupings of lines. For example, the controller 201 moves headland guidance lines based on a shift to a boundary line to maintain a defined distance between the boundary line and the headland field guidance lines. Once the controller 201 receives the modification, a user may create another field guidance plan template using the modified attribute values via the template creation button 330.

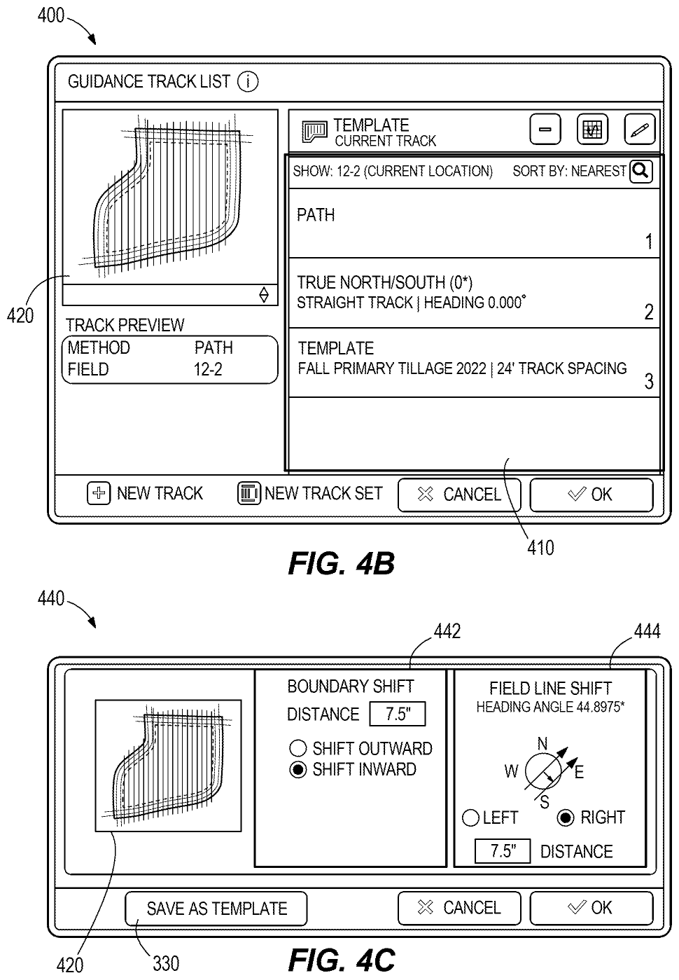

FIG. 5 is an example of a method in which the controller 201 creates a field guidance plan template, according to implementations in the present disclosure. The controller 201 receives an attribute for an operation for a defined area (step 501). In some implementations, the controller 201 receives a set of attributes associated with a single field operation of the off-road work vehicle 140. The set of attributes includes off-road work vehicle position attributes and/or work field attributes. In some instances, the controller collects information associated with an attribute of the set of attributes during operation of the off-road work vehicle 140. The controller 201 generates a field guidance plan for the defined area (step 503). In some implementations, the controller 201 generates a digital map that corresponds to the work field 120. The field guidance plan includes field guidance lines that are designed to assist the off-road work vehicle in traversing the work field 120.

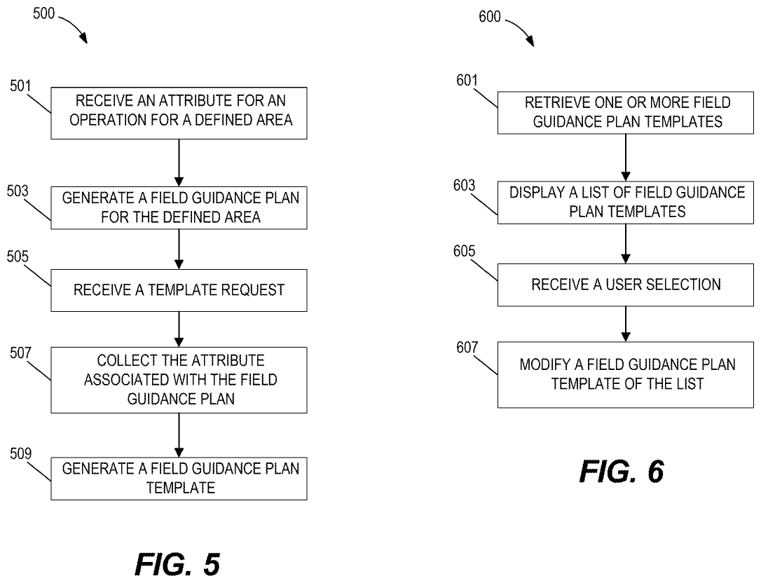

The controller 201 receives a template request (step 505). In some implementations, the controller 201 receives an indication from the user via the template creation button 330 of a graphical user interface. The controller 201 collects the set of attributes associated with the field guidance plan (step 507). In some implementations, the controller 201 stores the input values associated with the set of attributes, metadata associated with a field operation of the field guidance plan, and the position of the field guidance lines of the field guidance plan in the memory 205. The controller 201 generates a field guidance plan template (step 509). In some implementations, the controller 201 uses the collected information stored in the memory 205 associated with the field guidance plan to create a modifiable field guidance plan template. In some implementations, the controller 201 uses the received set of attributes (e.g., off-road work vehicle position attributes and/or work field attributes) associated with a single field operation of the off-road work vehicle 140 to generate the modifiable field guidance plan template. In those implementations, the modifiable field guidance plan template is created independently of a field guidance plan associated with the received set of attributes and can therefore be used for future field guidance plans. FIG. 6 is an example of a method in which the controller 201 modifies a field guidance plan template, according to implementations in the present disclosure. The controller 201 retrieves one or more field guidance plan templates (step 601). In some implementations, the controller 201 retrieves one or more field guidance plan templates from the memory 205. In some instances, the controller 201 retrieves the one or more field guidance plan templates using a location of the off-road work vehicle 140 and location associated with the one or more field guidance plan templates. The controller 201 displays a list of field guidance plan templates (step 603). In some implementations, the controller 201 generates a graphical user interface that includes the one or more field guidance plan templates retrieved from the memory 205. The controller 201 receives a user selection (step 605). In some implementations, the controller 201 receives, via an interface, a user selection of a field guidance plan template of the graphical user interface. The controller 201 modifies the field guidance plan template of the list (step 607). In some implementations, the controller 201 shifts a position of a boundary line and/or a field guidance line of the field guidance plan template using values received from the user.

Accordingly, the systems and methods described in this disclosure provide, among other things, a field guidance plan mechanism to retain data (e.g., attributes and metadata) associated with a field guidance plan designed for a single field operation and create a field guidance plan template that is reusable for another field operation. The mechanism also modifies a field guidance plan as built for a field operation and work field and triggers alerts that indicate to a user or operator that corrections are required to adhere to the field guidance plan being executed. Other features and advantages are set forth in the following claims.

What is claimed is:

1. A field guidance plan system comprising:
an electronic controller configured to
receive, via an interface of an off-road work vehicle, a set of attributes associated with a defined area of a work field for a field operation of the off-road work vehicle, wherein the set of attributes defines features of the work field;
generate a field guidance plan for the defined area of the work field, the field guidance plan designed to assist the off-road work vehicle in traversing the defined area during the field operation, wherein the field guidance plan includes a set of field guidance lines;
extract the set of attributes of each field guidance line of the set of field guidance lines in the field guidance plan; and
create and store a field guidance plan template based at least in part on the set of attributes and the field operation.

2. The system of claim 1, wherein the set of attributes includes at least one selected from a group consisting of a machine track spacing, heading angle, a headland definition, and field boundary.

3. The system of claim 1, wherein the electronic controller is configured to
identify at least two field guidance plan templates, wherein the at least two field guidance plan templates are displayed via a user interface on a display screen;
receive, via the user interface, a user selection of one of the at least two field guidance plan templates; and
display an image of the selected field guidance plan template.

4. The system of claim 3, wherein the electronic controller is configured to identify the at least two field guidance plan templates by identifying information related to an off-road work vehicle location and a location associated with the at least two field guidance plan templates.

5. The system of claim 3, wherein the field operation is a first field operation, and wherein the electronic controller is configured to
modify the selected field guidance plan template based on a second field operation of the off-road work vehicle, wherein the second field operation is different from the first field operation.

6. The system of claim 5, wherein the electronic controller is configured to modify the selected field guidance plan template by shifting at least a boundary line of the defined area of the work field in the selected field guidance plan template.

7. The system of claim 5, wherein the electronic controller is configured to modify the selected field guidance plan template by shifting at least a portion of a boundary line of the defined area of the work field in the selected field guidance plan template.

8. The system of claim 5, wherein the electronic controller is configured to modify the selected field guidance plan template by shifting at least a portion of at least one field guidance line of the set of field guidance lines of the defined area of the work field in the selected field guidance plan template, the set of field guidance lines corresponding to rows within the defined area of the work field.

9. The system of claim 5, wherein the electronic controller is configured to modify the selected field guidance plan template by extending at least a portion of at least one field guidance line of the set of field guidance lines of the defined area of the work field in the selected field guidance plan template, the at least one field guidance line corresponding to a row of a set of rows within the defined area of the work field.

10. The system of claim 5, wherein the electronic controller is configured to create a second field guidance plan template based on the modified field guidance plan template.

11. The system of claim 1, wherein the electronic controller is configured to transmit, via the interface, a notification to a user, the notification indicating that the off-road work vehicle is not travelling along a field guidance line.

12. A field guidance plan system comprising:
an electronic controller configured to
receive a set of attributes associated with a defined area of a tract of land for an operation of an off-road work vehicle;
generate a field guidance plan for the defined area of the field, the field guidance plan designed to assist the off-road work vehicle in traversing the defined area during a field operation; and
create a field guidance plan template based on the set of attributes and the field operation.

13. The system of claim 12, wherein the field operation is a first field operation, and wherein the electronic controller is configured to modify the field guidance plan template based on a second field operation of the off-road work vehicle, wherein the second field operation is different from the first field operation.

14. The system of claim 13, wherein, the electronic controller is configured to modify the field guidance plan template by shifting a boundary line of the field guidance plan template.

15. The system of claim 13, wherein the electronic controller is configured to modify the field guidance plan template by shifting a field guidance line of the field guidance plan template.

16. A non-transitory computer-readable medium comprising instructions that, when executed by an electronic processor, cause the electronic processor to perform a set of operations comprising:
receiving, with an interface of an off-road work vehicle, a set of attributes associated with a defined area of a work field for a field operation of the off-road work vehicle, wherein the set of attributes defines features of the work field;
generating a field guidance plan for the defined area of the work field, the field guidance plan designed to assist the off-road work vehicle in traversing the defined area during the field operation and discarded after the field operation is complete, wherein the field guidance plan includes a set of field guidance lines;
extracting the set of attributes of each field guidance line of the set of field guidance lines in the field guidance plan; and
creating and storing a field guidance plan template based at least in part on the set of attributes and the field operation.

17. The non-transitory computer-readable medium of claim 16, further comprising:
identifying at least two field guidance plan templates, wherein the at least two field guidance plan templates are displayed via a user interface on a display screen;
receiving, via the user interface, a user selection of one of the at least two field guidance plan templates; and
displaying an image of the selected field guidance plan template.

18. The non-transitory computer-readable medium of claim 17, wherein the field operation is a first field operation, further comprising:
modifying the selected field guidance plan template based on a second field operation of the off-road work vehicle, wherein the second field operation is different from the first field operation.

19. The non-transitory computer-readable medium of claim 18, wherein modifying the selected field guidance plan template further comprises:
shifting at least a boundary line of the defined area of the work field in the selected field guidance plan template.

20. The non-transitory computer-readable medium of claim 18, wherein modifying the selected field guidance plan template further comprises:
shifting at least a portion of at least one field guidance line of the set of field guidance lines of the defined area of the work field in the selected field guidance plan template, the at least one field guidance line corresponding to a row of a set of rows within the defined area of the work field.
